(19) United States
(12) Patent Application Publication
(10) Pub. No.: US 2026/0056797 A1
(43) Pub. Date: Feb. 26, 2026

(54) CLOUD DISK SCHEDULING METHOD, DEVICE, AND STORAGE MEDIUM BASED ON ELASTIC BLOCK STORAGE SERVICE

(71) Applicant: Beijing Volcano Engine Technology Co., Ltd., Beijing (CN)

(72) Inventors: Hang ZHANG, Beijing (CN); Pengwei ZHAO, Beijing (CN); Haijia SHEN, Beijing (CN); Fenghao ZHANG, Beijing (CN); Haibin SHE, Beijing (CN); Xianghui ZHOU, Beijing (CN); Kai LI, Beijing (CN); Yunhao LI, Beijing (CN); Jianong ZHONG, Beijing (CN); Rusong JIAO, Beijing (CN); Jiebin LUO, Beijing (CN)

(21) Appl. No.: 19/305,644

(22) Filed: Aug. 20, 2025

(30) Foreign Application Priority Data
Aug. 20, 2024 (CN) 202411147265.4

(51) Int. Cl. G06F 9/50

(52) U.S. Cl. CPC G06F 9/5038; G06F 9/5033

(57) ABSTRACT

Embodiments of the present disclosure provide a cloud disk scheduling method, device and a storage medium based on an elastic block storage service. The method includes: obtaining historical cloud disk usage status information of a user to whom a cloud disk to-be-created belongs and current storage status information of each storage cluster, and predicting a predicted compression rate of each storage cluster in a case that the cloud disk to-be-created is created in different storage clusters; and determining a target storage cluster from each storage cluster according to the predicted compression rate of each storage cluster, such that a difference among compression rates of all storage clusters is minimized after the cloud disk to-be-created is created in the target storage cluster.

### CROSS-REFERENCE TO RELATED APPLICATION(S)

This application claims priority to Chinese Application No. 202411147265.4 filed Aug. 20, 2024, the disclosure of which is incorporated herein by reference in its entirety.

### FIELD

Embodiments of the present disclosure relate to the field of computer and network communication technologies, and in particular, to a cloud disk scheduling method, device and a storage medium based on an elastic block storage service.

### BACKGROUND

Currently, in a cloud computing architecture, a user deploys and runs an application by purchasing a virtual machine (VM) of an elastic computing service (ECS), and the virtual machine provides a data persistence capability by mounting a block device (or may also be referred to as a cloud disk) of elastic block storage (EBS). To reduce a requirement for storage space and improve storage efficiency, a data compression technology is introduced in a writing path.

### SUMMARY

Embodiments of the present disclosure provide a cloud disk scheduling method, device and a storage medium based on an elastic block storage service.

In a first aspect, an embodiment of the present disclosure provides a cloud disk scheduling method based on an elastic block storage service, including:
obtaining historical cloud disk usage status information of a user to whom a cloud disk to be created belongs, and current storage status information of each storage cluster, where any storage cluster includes one or more created cloud disks;
according to the historical cloud disk usage status information and the current storage status information of each storage cluster, predicting a predicted compression rate of each storage cluster in a case that the cloud disk to be created is created in different storage clusters; and
according to the predicted compression rate of each storage cluster, determining a target storage cluster from each storage cluster, and creating the cloud disk to be created in the target storage cluster, such that a difference among compression rates of all storage clusters is minimized after the cloud disk to be created is created in the target storage cluster.

In a second aspect, an embodiment of the present disclosure provides a cloud disk scheduling device based on an elastic block storage service, including:
an obtaining unit, configured to obtain historical cloud disk usage status information of a user to whom a cloud disk to be created belongs, and current storage status information of each storage cluster, where any storage cluster includes one or more created cloud disks;
a predicting unit, configured to predict, according to the historical cloud disk usage status information and the current storage status information of each storage cluster, a predicted compression rate of each storage cluster in a case that the cloud disk to be created is created in different storage clusters; and
a selecting unit, configured to determine a target storage cluster from each storage cluster according to the predicted compression rate of each storage cluster, and create the cloud disk to be created in the target storage cluster, such that a difference among compression rates of all storage clusters is minimized after the cloud disk to be created is created in the target storage cluster.

In a third aspect, an embodiment of the present disclosure provides an electronic device, including: at least one processor and a memory;
where the memory stores computer-executable instructions; and
the at least one processor executes the computer-executable instructions stored in the memory, to enable the at least one processor to perform the cloud disk scheduling method based on an elastic block storage service according to the above first aspect and various possible designs of the first aspect.

In a fourth aspect, an embodiment of the present disclosure provides a computer-readable storage medium, where computer-executable instructions are stored in the computer-readable storage medium, and when a processor executes the computer-executable instructions, the cloud disk scheduling method based on an elastic block storage service according to the above first aspect and various possible designs of the first aspect is implemented.

In a fifth aspect, an embodiment of the present disclosure provides a computer program product, including computer-executable instructions, where when a processor executes the computer-executable instructions, the cloud disk scheduling method based on an elastic block storage service according to the above first aspect and various possible designs of the first aspect is implemented.

According to the cloud disk scheduling method, device and storage medium based on an elastic block storage service provided in the embodiments of the present disclosure, the historical cloud disk usage status information of the user to whom the cloud disk to be created belongs and the current storage status information of each storage cluster are obtained, where any storage cluster includes one or more created cloud disks; the predicted compression rate of each storage cluster in the case that the cloud disk to be created is created in different storage clusters is predicted according to the historical cloud disk usage status information and the current storage status information of each storage cluster; and the target storage cluster is determined from each storage cluster according to the predicted compression rate of each storage cluster, and the cloud disk to be created is created in the target storage cluster, such that the difference among the compression rates of all storage clusters is minimized after the cloud disk to be created is created in the target storage cluster.

### BRIEF DESCRIPTION OF THE DRAWINGS

In order to illustrate the technical solutions in the embodiments of the present disclosure or in the prior art more clearly, the following briefly introduces the drawings required for describing the embodiments or the prior art. Apparently, the drawings in the following description show some embodiments of the present disclosure, and a person of ordinary skill in the art may still derive other drawings from these drawings without creative efforts.

FIG. 1 is a schematic diagram of a scenario of a cloud disk scheduling method based on an elastic block storage service according to an embodiment of the present disclosure;

FIG. 2 is a schematic flowchart of a cloud disk scheduling method based on an elastic block storage service according to an embodiment of the present disclosure;

FIG. 3 is a schematic flowchart of a cloud disk scheduling method based on an elastic block storage service according to another embodiment of the present disclosure;

FIG. 4 is a block diagram of a structure of a cloud disk scheduling device based on an elastic block storage service according to an embodiment of the present disclosure; and

FIG. 5 is a schematic diagram of a hardware structure of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and comprehensively below with reference to the drawings in the embodiments of the present disclosure. Apparently, the described embodiments are merely some embodiments of the present disclosure, but not all embodiments. All other embodiments obtained by a person of ordinary skill in the art based on the embodiments of the present disclosure without creative efforts shall fall within the protection scope of the present disclosure.

Data compression rates of different users are different, resulting in unbalanced resource allocation when cloud disk scheduling is performed based on various cloud disk scheduling policies in the prior art, which affects effective utilization of resources and transmission bandwidth. In the prior art, a cloud disk scheduling policy usually does not consider a difference in data compression rates of different users. For example, data forms of different users are different, and different compression algorithms are used. However, there is a relatively large difference in data compression rates of different users, which may result in unbalanced resource allocation and in particular, cause an excessively high compression rate of some storage clusters and an excessively low compression rate of some other storage clusters. An excessively high compression rate requires a relatively large transmission bandwidth during data reading and writing, and at the same time, the number of disk reads and writes increases, resulting in more disk wear, shortening a service life of the disk, and increasing a risk of data damage. Moreover, a loss caused by data damage is also relatively large (because an actual amount of data stored in a storage cluster with a high compression rate is relatively large, and a loss caused by a failure of a single storage cluster is also relatively large).

To solve the above technical problem, an embodiment of the present disclosure provides a cloud disk scheduling method based on an elastic block storage service. When a user creates a cloud disk, a problem of a balanced compression rate of each storage cluster is considered, and an appropriate target storage cluster is selected for a cloud disk to be created, so that the compression rate of each storage cluster remains relatively balanced after the cloud disk to be created is created in the target storage cluster. In this way, dynamic allocation of storage resources can be implemented reasonably, a single storage cluster is prevented from being overloaded and resources from being wasted, disk wear of each storage cluster is effectively balanced, stability of the storage system and balance of a fault domain are improved, and an excessive impact caused by a failure of a single storage cluster is avoided.

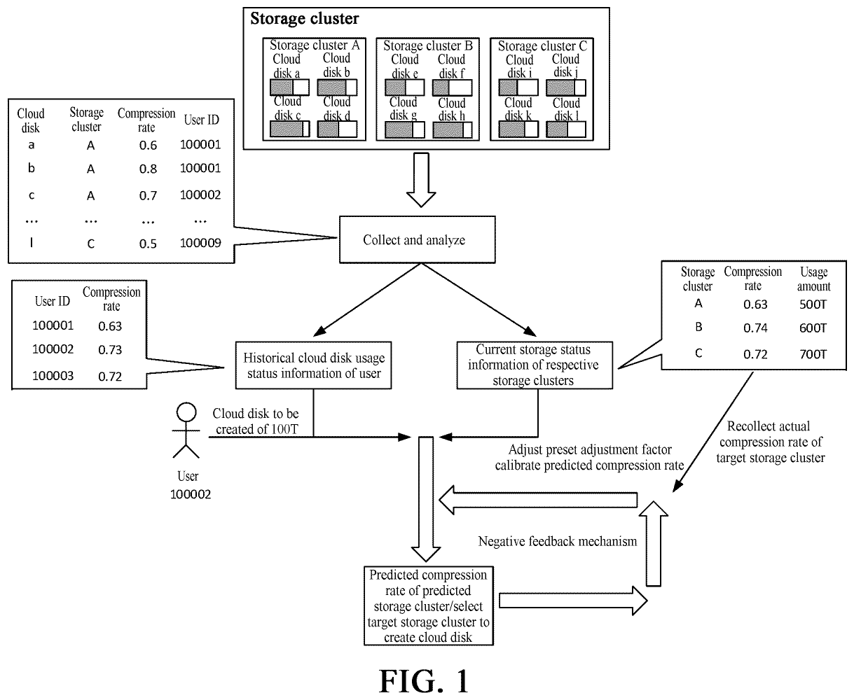

Specifically, as shown in FIG. 1, the historical cloud disk usage status information of the user to whom the cloud disk to be created belongs and the current storage status information of each storage cluster are obtained, where any storage cluster includes one or more created cloud disks; the predicted compression rate of each storage cluster in the case that the cloud disk to be created is created in different storage clusters is predicted according to the historical cloud disk usage status information and the current storage status information of each storage cluster; and the target storage cluster is determined from each storage cluster according to the predicted compression rate of each storage cluster, such that the difference among the compression rates of all storage clusters is minimized after the cloud disk to be created is created in the target storage cluster.

Optionally, a negative feedback mechanism may also be introduced to dynamically adjust prediction accuracy through a preset adjustment factor, where the preset adjustment factor may be determined according to a difference between a predicted compression rate and an actual compression rate of a historical target storage cluster in a historical cloud disk creation process and a preset learning rate. The preset adjustment factor is dynamically changed by learning the difference between the predicted compression rate and the actual compression rate, thereby implementing correction of the predicted compression rate. The negative feedback mechanism improves adaptability of the storage system to future user-level data changes. When a service mode of a single user changes, the predicted compression rate can be quickly calibrated iteratively, thereby maintaining efficient storage performance and resource utilization.

It should be noted that user information (including but not limited to user device information, user personal information, etc.) and data (including but not limited to data for analysis, data for storage, data for display, etc.) involved in the present disclosure are information and data authorized by users or fully authorized by parties, and collection, use and processing of relevant data need to comply with relevant laws, regulations and standards of relevant countries and regions, and corresponding operation entry is provided for users to choose to authorize or reject.

The cloud disk scheduling method based on an elastic block storage service of the present disclosure will be described in detail below with reference to specific embodiments.

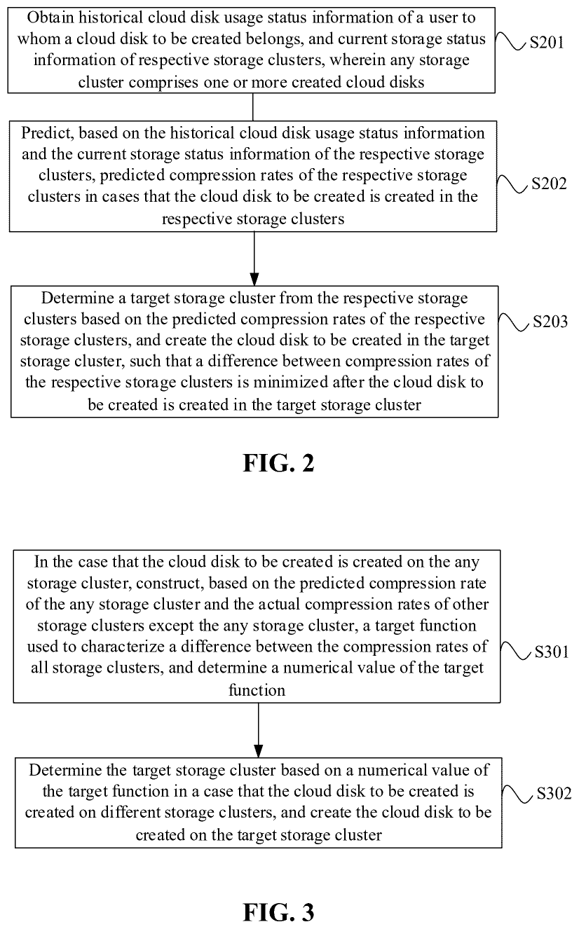

Referring to FIG. 2, FIG. 2 is a schematic flowchart of a cloud disk scheduling method based on an elastic block storage service according to an embodiment of the present disclosure. The method of this embodiment may be applied to a terminal device or a server, and the cloud disk scheduling method based on an elastic block storage service includes:
S201, historical cloud disk usage status information of a user to whom a cloud disk to be created belongs, and current storage status information of each storage cluster is obtained, where any storage cluster includes one or more created cloud disks.

In this embodiment, in an elastic block storage service (ECS) of a cloud computing architecture, when a user needs to create a new cloud disk, the user may create the new cloud disk on a certain storage cluster, and the storage cluster includes one or more created cloud disks, which may be created by any user. The cloud disk, as a block device, may be attached to an elastic block storage service instance for storing data.

When the user needs to create a cloud disk, the user may refer to historical cloud disk usage status information of the user, where the historical cloud disk usage status information of the user includes but is not limited to an average cloud disk usage rate of the user, a historical compression rate, etc., to predict a usage status of the cloud disk to be created.

In addition, to keep the compression rate of each storage cluster in the cloud computing architecture relatively balanced after the cloud disk to be created is created in a certain storage cluster in the cloud computing architecture, it is necessary to consider the current storage status information of each storage cluster. The current storage status information of each storage cluster includes but is not limited to a current total capacity of any storage cluster, an average usage rate of cloud disks included in any storage cluster, a current compression rate of any storage cluster, etc., which is used as basic information for selecting a storage cluster when the cloud disk to be created is created.

During specific implementation, the historical cloud disk usage status information of each user may be collected to obtain a historical cloud disk usage status information dataset. More specifically, a historical compression rate of each user may be collected to obtain a compression rate data subset, and an average cloud disk usage rate of each user may be collected to obtain a usage rate data subset. In addition, the current storage status information of each storage cluster may be collected to obtain a storage status information dataset, which will not be described in detail here. Optionally, in this embodiment, usage status information may be collected for each cloud disk in the cloud computing architecture, and then the cloud disks may be analyzed according to a user granularity to obtain the historical cloud disk usage status information dataset, and the cloud disks may be analyzed according to a cluster granularity to obtain the storage status information dataset. Through the above collection and analysis process, data support may be provided for subsequent cloud disk scheduling and storage resource optimization.

Optionally, if the user to whom the cloud disk to be created belongs is an existing user, the historical cloud disk usage status information of the user may be collected. If the user to whom the cloud disk to be created belongs is a new user, that is, there is no historical cloud disk usage status information, or the user to whom the cloud disk to be created belongs has created a small number of cloud disks or in other cases, the historical cloud disk usage status information of the user is little or inaccurate, resulting in the historical cloud disk usage status information of the user being unavailable, the historical cloud disk usage status information of the user may be predicted. Specifically, similar user groups of the user to whom the cloud disk to be created belongs may be determined, for example, user groups in similar industries, user groups with similar purposes, etc. The similar user groups may be found based on user attributes, and then the historical cloud disk usage status information of the similar user groups (an average value of the historical cloud disk usage status information of the user groups may be used, or the historical cloud disk usage status information of one of the most similar users may be used) is determined as the historical cloud disk usage status information of the user to whom the cloud disk to be created belongs.
S202, according to the historical cloud disk usage status information and the current storage status information of each storage cluster, a predicted compression rate of each storage cluster in a case that the cloud disk to be created is created in different storage clusters is predicted.

In this embodiment, to keep the compression rate of each storage cluster in the cloud computing architecture relatively balanced after the cloud disk to be created is created in a certain storage cluster in the cloud computing architecture, it may be assumed that the cloud disk to be created is created in different storage clusters, and the predicted compression rate of the storage cluster on which the cloud disk to be created is created in each case is predicted, so as to facilitate subsequent measurement of which case has a more balanced compression rate of each storage cluster in the cloud computing architecture. The cloud disk to be created is created in a certain storage cluster, that is, after the cloud computing architecture allocates storage resources for the cloud disk to be created, the cloud disk to be created is added to a certain storage cluster for management.

The predicted compression rate of each storage cluster in the case that the cloud disk to be created is created in different storage clusters is predicted based on the historical cloud disk usage status information of the user to whom the cloud disk to be created belongs and the current storage status information of each storage cluster obtained in the above step.

Optionally, the prediction may be implemented by the following process.

A ratio of a first data amount after compression to a second data amount before compression in the any storage cluster in the case that the cloud disk to be created is created in the any storage cluster is determined according to the historical cloud disk usage status information and the current storage status information of the any storage cluster, and the predicted compression rate of the any storage cluster is obtained according to the ratio.

In this embodiment, in the case that it is assumed that the cloud disk to be created is created in the any storage cluster, the data amount of the data in the storage cluster before and after compression when the cloud disk to be created is created in the storage cluster may be predicted based on the historical cloud disk usage status information of the user to whom the cloud disk to be created belongs and the current storage status information of the storage cluster, and the ratio of the first data amount after compression to the second data amount before compression is calculated. The predicted compression rate of the storage cluster is obtained according to the ratio. Any feasible algorithm may be used to predict the data amount of the data in the storage cluster before and after compression.

Certainly, based on the historical cloud disk usage status information of the user to whom the cloud disk to be created belongs and the current storage status information of each storage cluster, any other feasible method may be used to predict the predicted compression rate of each storage cluster in the case that the cloud disk to be created is created in different storage clusters, for example, prediction by an artificial intelligence model or other algorithms, which is not limited here.
S203, a target storage cluster from each storage cluster is determined according to the predicted compression rate of each storage cluster, and the cloud disk to be created is created in the target storage cluster, such that a difference among compression rates of all storage clusters is minimized after the cloud disk to be created is created in the target storage cluster.

In this embodiment, after it is assumed in the above step that the cloud disk to be created is created in different storage clusters and the predicted compression rate of the storage cluster on which the cloud disk to be created is created in each case is predicted, the difference among the compression rates of all storage clusters in each case may be determined based on the predicted compression rate of each storage cluster, and then it may be determined that the difference among the compression rates of all storage clusters in a certain case is minimized. This case is used as an optimal deployment policy, that is, the cloud disk to be created is created in the target storage cluster specified in this case, so that the compression rate of each storage cluster in the cloud computing architecture remains relatively balanced.

According to the cloud disk scheduling method based on an elastic block storage service provided in this embodiment, the historical cloud disk usage status information of the user to whom the cloud disk to be created belongs and the current storage status information of each storage cluster are obtained, where any storage cluster includes one or more created cloud disks; the predicted compression rate of each storage cluster in the case that the cloud disk to be created is created in different storage clusters is predicted according to the historical cloud disk usage status information and the current storage status information of each storage cluster; and the target storage cluster is determined from each storage cluster according to the predicted compression rate of each storage cluster, and the cloud disk to be created is created in the target storage cluster, such that the difference among the compression rates of all storage clusters is minimized after the cloud disk to be created is created in the target storage cluster. In this embodiment, when the cloud disk is created, the problem of the balanced compression rate of the storage cluster is considered, and the appropriate target storage cluster is selected for the cloud disk to be created, so that the compression rate of each storage cluster remains relatively balanced after the cloud disk to be created is created in the target storage cluster, thereby implementing dynamic allocation of storage resources reasonably, avoiding a single storage cluster from being overloaded and resources from being wasted, effectively balancing disk wear of each storage cluster, improving stability of the storage system and balance of the fault domain, and avoiding an excessive impact caused by a failure of a single storage cluster.

The cloud disk scheduling method based on an elastic block storage service provided in this embodiment may be applied to a cloud computing architecture of any scale. In particular, in a scenario without a large number of clusters and users, problems caused by unbalanced compression rates are more prominent. With the cloud disk scheduling method based on an elastic block storage service in this embodiment, the compression rate of each storage cluster in the cloud computing framework of any scale can be balanced, thereby implementing efficient and reasonable utilization of resources.

Optionally, the determining the ratio of the first data amount after compression to the second data amount before compression in the any storage cluster in the case that the cloud disk to be created is created in the any storage cluster specifically includes:
determining, according to the current storage status information of the any storage cluster, a third data amount after compression and a fourth data amount before compression in the any storage cluster before the cloud disk to be created is created in the any storage cluster;
determining, according to the historical cloud disk usage status information, a fifth data amount after compression and a sixth data amount before compression in the cloud disk to be created; and
determining a sum of the third data amount and the fifth data amount as the first data amount, determining a sum of the fourth data amount and the sixth data amount as the second data amount, and obtaining a ratio of the first data amount to the second data amount.

In this embodiment, the data amount of the data in the storage cluster before and after compression at the current moment may be determined based on the current storage status information of the storage cluster, that is, the third data amount after compression and the fourth data amount before compression in the storage cluster before the cloud disk to be created is created in the storage cluster.

During specific implementation, a product of the current total capacity of the storage cluster and the average usage rate of the cloud disks included in the storage cluster may be obtained and used as the fourth data amount before compression of the data currently stored in the storage cluster. A product of the current total capacity of the storage cluster, the average usage rate of the cloud disks included in the storage cluster, and the current compression rate of the storage cluster is obtained and used as the third data amount after compression in the storage cluster, that is, the data amount of the data currently stored in the storage cluster which is compressed at the current compression rate of the storage cluster based on the fourth data amount before compression of the data currently stored in the storage cluster.

In addition, the data amount of the data to be stored in the future in the cloud disk to be created before and after compression may also be predicted based on the historical cloud disk usage status information of the user to whom the cloud disk to be created belongs, that is, the fifth data amount after compression and the sixth data amount before compression in the cloud disk to be created.

During specific implementation, a product of the average cloud disk usage rate of the user to whom the cloud disk to be created belongs, the number of cloud disks to be created, and the average capacity of the cloud disk to be created may be obtained and used as the sixth data amount before compression in the cloud disk to be created. A product of the average cloud disk usage rate of the user and the average capacity of the cloud disk to be created is a predicted data amount to be stored in a single cloud disk to be created, and then the product of the average cloud disk usage rate of the user and the average capacity of the cloud disk to be created is multiplied by the number of cloud disks to be created to obtain a predicted data amount to be stored in all cloud disks to be created, that is, the sixth data amount before compression in the cloud disk to be created. A product of the average cloud disk usage rate of the user to whom the cloud disk to be created belongs, the historical compression rate of the user, the number of cloud disks to be created, and the average capacity of the cloud disk to be created is obtained and used as the fifth data amount after compression in the cloud disk to be created. That is, the sixth data amount before compression in the cloud disk to be created is multiplied by the historical compression rate of the user to obtain a data amount obtained after the sixth data amount before compression in the cloud disk to be created is compressed, that is, the fifth data amount after compression in the cloud disk to be created.

Further, the third data amount is added to the fifth data amount to obtain the first data amount after compression in the storage cluster in the case that the cloud disk to be created is created in the storage cluster, and the fourth data amount is added to the sixth data amount to obtain the second data amount in the storage cluster in the case that the cloud disk to be created is created in the storage cluster. Then, the first data amount is compared with the second data amount to obtain the ratio, and the predicted compression rate of the storage cluster is obtained according to the ratio.

Optionally, in the above embodiment, the obtained ratio may be directly determined as the predicted compression rate of the storage cluster. Alternatively, a negative feedback mechanism may also be introduced. A preset adjustment factor may be multiplied by the obtained ratio, and a product is determined as the predicted compression rate of the storage cluster, so as to dynamically adjust prediction accuracy through the preset adjustment factor. The preset adjustment factor may be determined according to a difference between a predicted compression rate and an actual compression rate of a historical target storage cluster in a historical cloud disk creation process and a preset learning rate. The preset adjustment factor is dynamically changed by learning the difference between the predicted compression rate and the actual compression rate, thereby implementing correction of the predicted compression rate. The negative feedback mechanism improves adaptability of the storage system to future user-level data changes. When a service mode of a single user changes, the predicted compression rate can be quickly calibrated iteratively, thereby maintaining efficient storage performance and resource utilization.

Specifically, in the case that it is assumed that the cloud disk to be created is created in the any storage cluster, the predicted compression rate r_{new} of the storage cluster may be calculated by using the following formula:

$${r}_{new} = \frac{{D}_{c} \cdot {C}_{c} \cdot {F}_{c} + {N}_{u} \cdot {S}_{u} \cdot {C}_{u} \cdot {F}_{u}}{{D}_{c} \cdot {C}_{c} + {N}_{u} \cdot {S}_{u} \cdot {F}_{u}} \cdot α$$

where D_{c} is the current total capacity of the storage cluster; C_{c} is the current compression rate of the storage cluster; F_{c} is the average usage rate of the cloud disks included in the storage cluster; Nᵤ is the number of cloud disks to be created; Sᵤ is the average capacity of the cloud disk to be created; Cᵤ is the historical compression rate of the user to whom the cloud disk to be created belongs; Fᵤ is the average cloud disk usage rate of the user to whom the cloud disk to be created belongs; and α is the preset adjustment factor.

Optionally, the preset adjustment factor α may be calculated by using the following formula:

$$α = α + β \cdot ( {r}_{actual} - {r}_{predicted} )$$

where β is the preset learning rate; r_{predicted} is the predicted compression rate of the historical target storage cluster in the historical cloud disk creation process, for example, the predicted compression rate calculated by using the above formula when the cloud disk to be created was assumed to be created in the historical target storage cluster last time; and r_{actual} is the actual compression rate of the historical target storage cluster in the historical cloud disk creation process, for example, the actual compression rate of the historical target storage cluster collected when the cloud disk to be created was actually created in the historical target storage cluster last time.

Based on any of the above embodiments, the step S203 of determining the target storage cluster from each storage cluster according to the predicted compression rate of each storage cluster, and creating the cloud disk to be created in the target storage cluster, such that the difference among the compression rates of all storage clusters is minimized after the cloud disk to be created is created in the target storage cluster, as shown in FIG. 3, may specifically include the following steps.
S301, in the case that the cloud disk to be created is created in the any storage cluster, according to the predicted compression rate of the any storage cluster and the actual compression rates of other storage clusters except the any storage cluster, a target function used to characterize a difference between the compression rates of all storage clusters is constructed, and a numerical value of the target function is determined; and
S302, the target storage cluster is determined according to a numerical value of the target function in a case that the cloud disk to be created is created in different storage clusters, and the cloud disk to be created is created in the target storage cluster.

In this embodiment, the target function used to characterize the difference between the compression rates of all storage clusters in the case that the cloud disk to be created is created in the any storage cluster may be constructed. The target function is constructed based on the compression rates of all storage clusters in the case. The compression rate of the storage cluster on which the cloud disk to be created is created is the predicted compression rate, while the actual compression rates of the other storage clusters are used. Then, based on the target function, it can be determined which case has the minimum difference among the compression rates of all storage clusters among different cases, that is, the compression rates among all storage clusters are the most balanced. The target function only needs to characterize the difference among the compression rates of all storage clusters in any case, and a construction method and a form of the target function are not limited in this embodiment.

Optionally, the target function may be constructed as follows.

A compression rate standard deviation, a maximum compression rate and a minimum compression rate of all storage clusters are determined according to the predicted compression rate of the any storage cluster and the actual compression rates of the other storage clusters except the any storage cluster.

The compression rate standard deviation of all storage clusters is normalized based on the maximum compression rate and the minimum compression rate, and the target function used to characterize the difference among the compression rates of all storage clusters is obtained based on a normalization result.

In this embodiment, in the case that the cloud disk to be created is created in the any storage cluster, the compression rate standard deviation, the maximum compression rate and the minimum compression rate of all storage clusters may be determined according to the predicted compression rate of the storage cluster and the actual compression rates of other storage clusters except the storage cluster. The compression rate standard deviation is a square root of an arithmetic mean of squared differences between the compression rate of each storage cluster and an average compression rate. Further, the compression rate standard deviation of all storage clusters is normalized based on the maximum compression rate and the minimum compression rate. The normalization result may be directly used as the target function, or the normalization result may be further modified. For example, the normalization result is subtracted from 1 to obtain the target function. A formula of the target function C is as follows:

$$C = 1 - \frac{\sqrt{\frac{1}{n} {\sum }_{i = 1}^{n} {( {r}_{i} - \overline{r} )}^{2}}}{{R}_{max} - {R}_{min}}$$

where rᵢ is the compression rate (the predicted compression rate or the actual compression rate) of the storage cluster i; r̅ is the average compression rate; n is the total number of all storage clusters; Rₘₐₓ is the maximum compression rate; and Rₘᵢₙ is the minimum compression rate.

In the target function C, when the compression rates of all storage clusters are equal, the value of the target function C is 1, representing that the compression rates of all storage clusters are in perfect balance. When the difference among the compression rates of all storage clusters is larger, the value of the target function C is closer to 0. Therefore, after the values of the target function C in all cases are calculated, a case with the value of the target function C closest to 1 may be selected. The difference among the compression rates of all storage clusters in this case is minimized. This case is used as the optimal deployment policy, that is, the cloud disk to be created is created in the target storage cluster specified in this case, so that the compression rate of each storage cluster in the cloud computing architecture remains relatively balanced.

Certainly, the construction of the target function in this embodiment is not limited to the above method. For example, the compression rate standard deviation or the variance may be directly used as the target function, or the target function may be constructed in other manners.

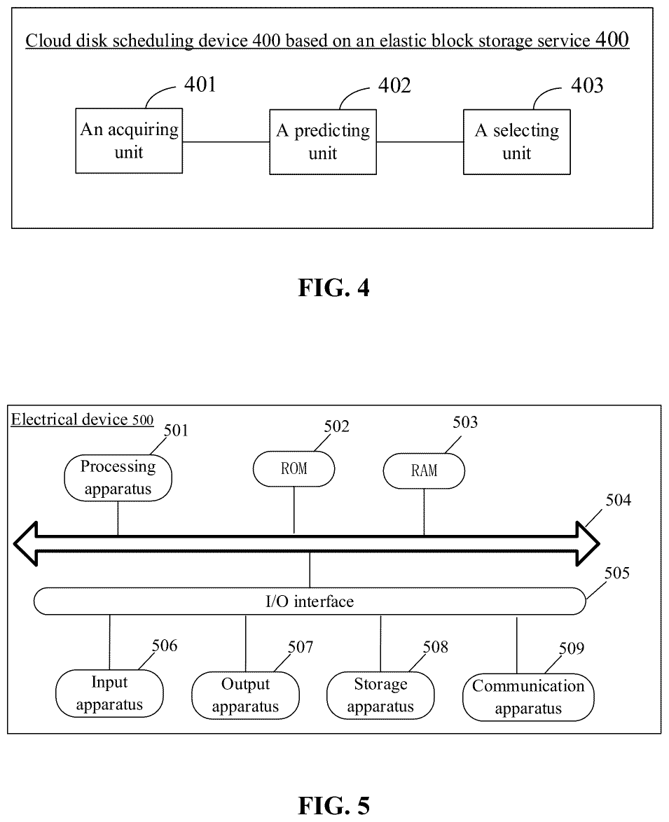

Corresponding to the cloud disk scheduling method based on an elastic block storage service in the above embodiment, FIG. 4 is a block diagram of a structure of a cloud disk scheduling device based on an elastic block storage service according to an embodiment of the present disclosure. For ease of description, only parts related to the embodiments of the present disclosure are shown. Referring to FIG. 4, the cloud disk scheduling device 400 based on an elastic block storage service includes: an obtaining unit 401, a predicting unit 402, and a selecting unit 403.

The obtaining unit 401 is configured to obtain historical cloud disk usage status information of a user to whom a cloud disk to be created belongs, and current storage status information of each storage cluster, where any storage cluster includes one or more created cloud disks.

The predicting unit 402 is configured to predict, according to the historical cloud disk usage status information and the current storage status information of each storage cluster, a predicted compression rate of each storage cluster in a case that the cloud disk to be created is created in different storage clusters.

The selecting unit 403 is configured to determine a target storage cluster from each storage cluster according to the predicted compression rate of each storage cluster, and create the cloud disk to be created in the target storage cluster, such that a difference among compression rates of all storage clusters is minimized after the cloud disk to be created is created in the target storage cluster.

In one or more embodiments of the present disclosure, when predicting, according to the historical cloud disk usage status information and the current storage status information of each storage cluster, the predicted compression rate of each storage cluster in the case that the cloud disk to be created is created in different storage clusters, the predicting unit 402 is configured to: determine, according to the historical cloud disk usage status information and the current storage status information of any storage cluster, a ratio of a first data amount after compression to a second data amount before compression in the any storage cluster in the case that the cloud disk to be created is created in the any storage cluster, and obtain the predicted compression rate of the any storage cluster according to the ratio.

In one or more embodiments of the present disclosure, when determining the ratio of the first data amount after compression to the second data amount before compression in the any storage cluster in the case that the cloud disk to be created is created in the any storage cluster according to the historical cloud disk usage status information and the current storage status information of the any storage cluster, the predicting unit 402 is configured to:
determine, according to the current storage status information of the any storage cluster, the third data amount after compression and the fourth data amount before compression in the any storage cluster before the cloud disk to be created is created in the any storage cluster;
determine, according to the historical cloud disk usage status information, the fifth data amount after compression and the sixth data amount before compression in the cloud disk to be created; and
determine a sum of the third data amount and the fifth data amount as the first data amount, determine a sum of the fourth data amount and the sixth data amount as the second data amount, and obtain a ratio of the first data amount to the second data amount.

In one or more embodiments of the present disclosure, when determining the third data amount after compression and the fourth data amount before compression in the any storage cluster according to the current storage status information of the any storage cluster before the cloud disk to be created is created in the any storage cluster, the predicting unit 402 is configured to:
obtain a product of the current total capacity of the any storage cluster, the average usage rate of the cloud disks included in the any storage cluster, and the current compression rate of the any storage cluster as the third data amount, and obtain a product of the current total capacity of the any storage cluster and the average usage rate of the cloud disks included in the any storage cluster as the fourth data amount; and/or
the determining, according to the historical cloud disk usage status information, the fifth data amount after compression and the sixth data amount before compression in the cloud disk to be created includes:
   obtaining a product of the average cloud disk usage rate of the user to whom the cloud disk to be created belongs, the historical compression rate of the user, the number of cloud disks to be created, and the average capacity of the cloud disk to be created as the fifth data amount, and obtaining a product of the average cloud disk usage rate of the user to whom the cloud disk to be created belongs, the number of cloud disks to be created, and the average capacity of the cloud disk to be created as the sixth data amount.

In one or more embodiments of the present disclosure, when obtaining the predicted compression rate of the any storage cluster according to the ratio, the predicting unit 402 is configured to:
determine a product of the ratio and the preset adjustment factor as the predicted compression rate of the any storage cluster;
where the preset adjustment factor is determined according to a difference between a predicted compression rate and an actual compression rate of a historical target storage cluster in a historical cloud disk creation process and a preset learning rate.

In one or more embodiments of the present disclosure, when determining the target storage cluster from each storage cluster according to the predicted compression rate of each storage cluster and creating the cloud disk to be created in the target storage cluster, such that the difference between the compression rates of all storage clusters is minimized after the cloud disk to be created is created in the target storage cluster, the selecting unit 403 is configured to:
in the case that the cloud disk to be created is created in the any storage cluster, constructing, according to the predicted compression rate of the any storage cluster and the actual compression rates of other storage clusters except the any storage cluster, a target function used to characterize a difference among the compression rates of all storage clusters, and determining a numerical value of the target function; and
determining the target storage cluster according to a numerical value of the target function in a case that the cloud disk to be created is created in different storage clusters, and creating the cloud disk to be created in the target storage cluster.

In one or more embodiments of the present disclosure, when constructing the target function used to characterize the difference among the compression rates of all storage clusters according to the predicted compression rate of the any storage cluster and the actual compression rates of the other storage clusters except the any storage cluster, the selecting unit 403 is configured to:
determine a compression rate standard deviation, a maximum compression rate and a minimum compression rate of all storage clusters according to the predicted compression rate of the any storage cluster and the actual compression rates of the other storage clusters except the any storage cluster; and
normalize the compression rate standard deviation of all storage clusters based on the maximum compression rate and the minimum compression rate, and obtain the target function used to characterize the difference among the compression rates of all storage clusters based on a normalization result.

In one or more embodiments of the present disclosure, when obtaining the historical cloud disk usage status information of the user to whom the cloud disk to be created belongs, the obtaining unit 401 is configured to:
if there is no historical cloud disk usage status information of the user to whom the cloud disk to be created belongs, or the historical cloud disk usage status information is unavailable, determine similar user groups of the user to whom the cloud disk to be created belongs, and determine historical cloud disk usage status information of the similar user groups as the historical cloud disk usage status information of the user to whom the cloud disk to be created belongs.

The device provided in this embodiment may be used to implement the technical solutions of the above method embodiments, and implementation principles and technical effects thereof are similar, which will not be described in detail in this embodiment.

Referring to FIG. 5, which shows a schematic diagram of a structure of an electronic device 500 suitable for implementing the embodiments of the present disclosure, and the electronic device 500 may be a terminal device or a server. The terminal device may include, but is not limited to, a mobile terminal such as a mobile phone, a laptop, a digital broadcast receiver, a personal digital assistant (abbreviated as PDA), a tablet computer, a portable media player (abbreviated as PMP) and an in-vehicle terminal (such as an in-vehicle navigation terminal), and a fixed terminal such as a digital TV and a desktop computer, etc. The electronic device shown in FIG. 5 is merely an example, and should not impose any limitation to the function and the range of use of the embodiments of the present disclosure.

As shown in FIG. 5, the electronic device 500 may include a processing apparatus (such as a central processing unit and a graphics processing unit) 501. The processing apparatus 501 may perform various appropriate actions and processing according to a program stored in a read-only memory (abbreviated as ROM) 502 or a program loaded from a storage apparatus 508 to a random-access memory (abbreviated as RAM) 503. The RAM 503 further stores various programs and data required for operations of the electronic device 500. The processing apparatus 501, the ROM 502 and the RAM 503 are connected to each other through a bus 504. An input/output (I/O) interface 505 is also connected to the bus 504.

Generally, the following apparatuses may be connected to the I/O interface 505: an input apparatus 506 including, for example, a touch screen, a touch pad, a keyboard, a mouse, a camera, a microphone, an accelerometer, a gyroscope, etc.; an output apparatus 507 including, for example, a liquid crystal display (abbreviated as LCD), a speaker, a vibrator, etc.; the storage apparatus 508 including, for example, a magnetic tape, a hard disk, etc.; and a communication apparatus 509. The communication apparatus 509 may allow the electronic device 500 to perform wireless or wired communication with other devices to exchange data. Although FIG. 5 shows the electronic device 500 having various apparatuses, it should be understood that not all of the illustrated apparatuses are necessarily implemented or included. Alternatively, more or fewer apparatuses may be implemented or included.

In particular, according to the embodiments of the present disclosure, the processes described above with reference to the flowcharts may be implemented as a computer software program. For example, an embodiment of the present disclosure includes a computer program product, which includes a computer program carried on a computer-readable medium, and the computer program includes program codes for executing the method shown in the flowcharts. In such an embodiment, the computer program may be downloaded and installed from a network via the communication apparatus 509, or installed from the storage apparatus 508, or installed from the ROM 502. When the computer program is executed by the processing apparatus 501, the above functions defined in the methods of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program that can be used by or in combination with an instruction execution system, apparatus, or device. In the present disclosure, the computer-readable signal medium may include a data signal propagated in a baseband or as a part of a carrier wave, and computer-readable program codes are carried in the data signal. The data signal propagated in this way may take many forms, including but not limited to an electromagnetic signal, an optical signal, or any suitable combination thereof. The computer-readable signal medium may also be any other computer-readable medium than the computer-readable storage medium. The computer-readable signal medium may send, propagate, or transmit a program used by or in combination with an instruction execution system, apparatus, or device. The program codes contained in the computer-readable medium may be transmitted by any suitable medium, including but not limited to an electric wire, an optical cable, a radio frequency (RF), etc., or any suitable combination thereof.

The above computer-readable medium may be included in the above electronic device, or may also exist alone without being assembled into the electronic device.

The above computer-readable medium carries one or more programs, and when the above one or more programs are executed by the electronic device, the electronic device is caused to perform the methods as shown in the above embodiments.

The computer program codes for executing the operations of the present disclosure may be written in one or more programming languages or a combination thereof. The above programming languages include object-oriented programming languages such as Java, Smalltalk, C++, and also include conventional procedural programming languages such as the “C” programming language or similar programming languages. The program codes may be executed entirely on a user's computer, partly on a user's computer, as a stand-alone software package, partly on a user's computer and partly on a remote computer, or entirely on a remote computer or a server. In the scenario involving the remote computer, the remote computer may be connected to the user's computer through any type of network, including a local area network (abbreviated as LAN) or a wide area network (abbreviated as WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or combinations of dedicated hardware and computer instructions.

The units involved in the embodiments of the present disclosure may be implemented in software or hardware. The name of a unit does not constitute a limitation on the unit itself under certain circumstances. For example, a first obtaining unit may also be described as “a unit for obtaining at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in conjunction with an instruction execution system, apparatus or device. The machine-readable medium may be a machine-readable signal medium or a machine-readable storage medium. The machine-readable medium may include, but not limited to, an electronic, magnetic, optical, electromagnetic, infrared, or semiconductor system, apparatus or device, or any suitable combination of the foregoing. More specific examples of the machine-readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the foregoing.

In a first aspect, according to one or more embodiments of the present disclosure, a cloud disk scheduling method based on an elastic block storage service is provided. The method includes:
obtaining historical cloud disk usage status information of a user to whom a cloud disk to be created belongs, and current storage status information of each storage cluster, where any storage cluster includes one or more created cloud disks;
predicting, according to the historical cloud disk usage status information and the current storage status information of each storage cluster, a predicted compression rate of each storage cluster in a case that the cloud disk to be created is created in different storage clusters; and
determining a target storage cluster from each storage cluster according to the predicted compression rate of each storage cluster, and creating the cloud disk to be created in the target storage cluster, such that a difference between compression rates of all storage clusters is minimized after the cloud disk to be created is created in the target storage cluster.

According to one or more embodiments of the present disclosure, the predicting, according to the historical cloud disk usage status information and the current storage status information of each storage cluster, the predicted compression rate of each storage cluster in the case that the cloud disk to be created is created in different storage clusters includes:
determining, according to the historical cloud disk usage status information and the current storage status information of any storage cluster, a ratio of a first data amount after compression to a second data amount before compression in the any storage cluster in the case that the cloud disk to be created is created in the any storage cluster, and obtaining the predicted compression rate of the any storage cluster according to the ratio.

According to one or more embodiments of the present disclosure, the determining, according to the historical cloud disk usage status information and the current storage status information of any storage cluster, the ratio of the first data amount after compression to the second data amount before compression in the any storage cluster in the case that the cloud disk to be created is created in the any storage cluster includes:
determining, according to the current storage status information of the any storage cluster, a third data amount after compression and a fourth data amount before compression in the any storage cluster before the cloud disk to be created is created in the any storage cluster;
determining, according to the historical cloud disk usage status information, a fifth data amount after compression and a sixth data amount before compression in the cloud disk to be created; and
determining a sum of the third data amount and the fifth data amount as the first data amount, determining a sum of the fourth data amount and the sixth data amount as the second data amount, and obtaining a ratio of the first data amount to the second data amount.

According to one or more embodiments of the present disclosure, the determining, according to the current storage status information of the any storage cluster, the third data amount after compression and the fourth data amount before compression in the any storage cluster before the cloud disk to be created is created in the any storage cluster includes:
obtaining a product of the current total capacity of the any storage cluster, the average usage rate of the cloud disks included in the any storage cluster, and the current compression rate of the any storage cluster as the third data amount, and obtaining a product of the current total capacity of the any storage cluster and the average usage rate of the cloud disks included in the any storage cluster as the fourth data amount; and/or
the determining, according to the historical cloud disk usage status information, the fifth data amount after compression and the sixth data amount before compression in the cloud disk to be created includes:
   obtaining a product of the average cloud disk usage rate of the user to whom the cloud disk to be created belongs, the historical compression rate of the user, the number of cloud disks to be created, and the average capacity of the cloud disk to be created as the fifth data amount, and obtaining a product of the average cloud disk usage rate of the user to whom the cloud disk to be created belongs, the number of cloud disks to be created, and the average capacity of the cloud disk to be created as the sixth data amount.

According to one or more embodiments of the present disclosure, the obtaining the predicted compression rate of the any storage cluster according to the ratio includes:
determining a product of the ratio and the preset adjustment factor as the predicted compression rate of the any storage cluster;
where the preset adjustment factor is determined according to a difference between a predicted compression rate and an actual compression rate of a historical target storage cluster in a historical cloud disk creation process and a preset learning rate.

According to one or more embodiments of the present disclosure, the determining the target storage cluster from each storage cluster according to the predicted compression rate of each storage cluster and creating the cloud disk to be created in the target storage cluster, such that the difference between the compression rates of all storage clusters is minimized after the cloud disk to be created is created in the target storage cluster includes:
in the case that the cloud disk to be created is created in the any storage cluster, constructing, according to the predicted compression rate of the any storage cluster and the actual compression rates of other storage clusters except the any storage cluster, a target function used to characterize a difference between the compression rates of all storage clusters, and determining a numerical value of the target function; and
determining the target storage cluster according to a numerical value of the target function in a case that the cloud disk to be created is created in different storage clusters, and creating the cloud disk to be created in the target storage cluster.

According to one or more embodiments of the present disclosure, the constructing, according to the predicted compression rate of the any storage cluster and the actual compression rates of the other storage clusters except the any storage cluster, the target function used to characterize the difference between the compression rates of all storage clusters includes:
determining the compression rate standard deviation, the maximum compression rate and the minimum compression rate of all storage clusters according to the predicted compression rate of the any storage cluster and the actual compression rates of the other storage clusters except the any storage cluster; and
normalizing the compression rate standard deviation of all storage clusters based on the maximum compression rate and the minimum compression rate, and obtaining the target function used to characterize the difference between the compression rates of all storage clusters based on a normalization result.

According to one or more embodiments of the present disclosure, the obtaining the historical cloud disk usage status information of the user to whom the cloud disk to be created belongs includes:
if there is no historical cloud disk usage status information of the user to whom the cloud disk to be created belongs, or the historical cloud disk usage status information is unavailable, determining similar user groups of the user to whom the cloud disk to be created belongs, and determining historical cloud disk usage status information of the similar user groups as the historical cloud disk usage status information of the user to whom the cloud disk to be created belongs.

In a second aspect, according to one or more embodiments of the present disclosure, a cloud disk scheduling device based on an elastic block storage service is provided. The cloud disk scheduling device includes:
an obtaining unit, configured to obtain historical cloud disk usage status information of a user to whom a cloud disk to be created belongs, and current storage status information of each storage cluster, where any storage cluster includes one or more created cloud disks;
a predicting unit, configured to predict, according to the historical cloud disk usage status information and the current storage status information of each storage cluster, a predicted compression rate of each storage cluster in a case that the cloud disk to be created is created in different storage clusters; and
a selecting unit, configured to determine a target storage cluster from each storage cluster according to the predicted compression rate of each storage cluster, and create the cloud disk to be created in the target storage cluster, such that a difference between compression rates of all storage clusters is minimized after the cloud disk to be created is created in the target storage cluster.

According to one or more embodiments of the present disclosure, when predicting, according to the historical cloud disk usage status information and the current storage status information of each storage cluster, the predicted compression rate of each storage cluster in the case that the cloud disk to be created is created in different storage clusters, the predicting unit is configured to:
determine, according to the historical cloud disk usage status information and the current storage status information of any storage cluster, a ratio of a first data amount after compression to a second data amount before compression in the any storage cluster in the case that the cloud disk to be created is created in the any storage cluster, and obtain the predicted compression rate of the any storage cluster according to the ratio.

According to one or more embodiments of the present disclosure, when determining the ratio of the first data amount after compression to the second data amount before compression in the any storage cluster in the case that the cloud disk to be created is created in the any storage cluster according to the historical cloud disk usage status information and the current storage status information of the any storage cluster, the predicting unit is configured to:
determine, according to the current storage status information of the any storage cluster, a third data amount after compression and a fourth data amount before compression in the any storage cluster before the cloud disk to be created is created in the any storage cluster;
determine, according to the historical cloud disk usage status information, a fifth data amount after compression and a sixth data amount before compression in the cloud disk to be created; and
determine a sum of the third data amount and the fifth data amount as the first data amount, determine a sum of the fourth data amount and the sixth data amount as the second data amount, and obtain a ratio of the first data amount to the second data amount.

According to one or more embodiments of the present disclosure, when determining the third data amount after compression and the fourth data amount before compression in the any storage cluster according to the current storage status information of the any storage cluster before the cloud disk to be created is created in the any storage cluster, the predicting unit is configured to:
obtain a product of the current total capacity of the any storage cluster, the average usage rate of the cloud disks included in the any storage cluster, and the current compression rate of the any storage cluster as the third data amount, and obtain a product of the current total capacity of the any storage cluster and the average usage rate of the cloud disks included in the any storage cluster as the fourth data amount; and/or
the determining, according to the historical cloud disk usage status information, the fifth data amount after compression and the sixth data amount before compression in the cloud disk to be created includes:
   obtaining a product of the average cloud disk usage rate of the user to whom the cloud disk to be created belongs, the historical compression rate of the user, the number of cloud disks to be created, and the average capacity of the cloud disk to be created as the fifth data amount, and obtaining a product of the average cloud disk usage rate of the user to whom the cloud disk to be created belongs, the number of cloud disks to be created, and the average capacity of the cloud disk to be created as the sixth data amount.

According to one or more embodiments of the present disclosure, when obtaining the predicted compression rate of the any storage cluster according to the ratio, the predicting unit is configured to:
determine a product of the ratio and the preset adjustment factor as the predicted compression rate of the any storage cluster;
where the preset adjustment factor is determined according to a difference between a predicted compression rate and an actual compression rate of a historical target storage cluster in a historical cloud disk creation process and a preset learning rate.

According to one or more embodiments of the present disclosure, the selecting unit, when determining the target storage cluster from each storage cluster according to the predicted compression rate of each storage cluster and creating the cloud disk to be created in the target storage cluster, such that the difference between the compression rates of all storage clusters is minimized after the cloud disk to be created is created in the target storage cluster, is configured to:
in the case that the cloud disk to be created is created in the any storage cluster, constructing, according to the predicted compression rate of the any storage cluster and the actual compression rates of other storage clusters except the any storage cluster, a target function used to characterize a difference between the compression rates of all storage clusters, and determining a numerical value of the target function; and
determining the target storage cluster according to a numerical value of the target function in a case that the cloud disk to be created is created in different storage clusters, and creating the cloud disk to be created in the target storage cluster.

According to one or more embodiments of the present disclosure, the selecting unit, when constructing the target function used to characterize the difference between the compression rates of all storage clusters according to the predicted compression rate of the any storage cluster and the actual compression rates of the other storage clusters except the any storage cluster, is configured to:
determine the compression rate standard deviation, the maximum compression rate and the minimum compression rate of all storage clusters according to the predicted compression rate of the any storage cluster and the actual compression rates of the other storage clusters except the any storage cluster; and
normalize the compression rate standard deviation of all storage clusters based on the maximum compression rate and the minimum compression rate, and obtain the target function used to characterize the difference among the compression rates of all storage clusters based on a normalization result.

According to one or more embodiments of the present disclosure, the obtaining unit, when obtaining the historical cloud disk usage status information of the user to whom the cloud disk to be created belongs, is configured to:
if there is no historical cloud disk usage status information of the user to whom the cloud disk to be created belongs, or the historical cloud disk usage status information is unavailable, determine similar user groups of the user to whom the cloud disk to be created belongs, and determine historical cloud disk usage status information of the similar user groups as the historical cloud disk usage status information of the user to whom the cloud disk to be created belongs.

In a third aspect, according to one or more embodiments of the present disclosure, an electronic device is provided. The electronic device includes: at least one processor and a memory.

The memory stores computer-executable instructions.

The at least one processor executes the computer-executable instructions stored in the memory to cause the at least one processor to execute the cloud disk scheduling method based on an elastic block storage service according to the above first aspect and various possible designs of the first aspect.

In a fourth aspect, according to one or more embodiments of the present disclosure, a computer-readable storage medium is provided. The computer-readable storage medium stores computer-executable instructions which, when executed by a processor, implement the cloud disk scheduling method based on an elastic block storage service according to the above first aspect and various possible designs of the first aspect.

In a fifth aspect, according to one or more embodiments of the present disclosure, a computer program product is provided. The computer program product includes computer-executable instructions which, when executed by a processor, implement the cloud disk scheduling method based on an elastic block storage service according to the above first aspect and various possible designs of the first aspect.

The above description is merely preferred embodiments of the present disclosure and an illustration of the applied technical principles. Those skilled in the art should understand that the disclosure scope involved in the present disclosure is not limited to the technical solutions formed by the specific combination of the above technical features, and should also cover, without departing from the above disclosure concept, other technical solutions formed by any combination of the above technical features or equivalent features thereof. For example, the technical solutions are formed by replacing the above features with the technical features having similar functions disclosed in the present disclosure (but not limited to).

In addition, although operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the methods, it should be understood that the subject matter defined in the appended claims is not necessarily limited to the specific features or actions described above. Rather, the specific features and actions described above are merely example forms for implementing the claims.

I/We claim:

1. A cloud disk scheduling method based on an elastic block storage service, comprising:
obtaining historical cloud disk usage status information of a user to whom a cloud disk to be created belongs, and current storage status information of respective storage clusters, wherein any storage cluster comprises one or more created cloud disks;
predicting, based on the historical cloud disk usage status information and the current storage status information of the respective storage clusters, predicted compression rates of the respective storage clusters in cases that the cloud disk to be created is created in the respective storage clusters; and
determining a target storage cluster from the respective storage clusters based on the predicted compression rates of the respective storage clusters, and creating the cloud disk to be created in the target storage cluster, such that a difference between compression rates of the respective storage clusters is minimized after the cloud disk to be created is created in the target storage cluster.

2. The method according to claim 1, wherein predicting, based on the historical cloud disk usage status information and the current storage status information of the respective storage clusters, the predicted compression rates of the respective storage clusters in the cases that the cloud disk to be created is created in the respective storage clusters comprises:
determining, based on the historical cloud disk usage status information and the current storage status information of any storage cluster, a ratio of a first data amount in the any storage cluster after compression to a second data amount in the any storage cluster before compression in a case that the cloud disk to be created is created in the any storage cluster, and obtaining a predicted compression rate of the any storage cluster based on the ratio.

3. The method according to claim 2, wherein determining, based on the historical cloud disk usage status information and the current storage status information of the any storage cluster, the ratio of the first data amount in the any storage cluster after compression to the second data amount in the any storage cluster before compression in the case that the cloud disk to be created is created in the any storage cluster comprises:
determining, based on the current storage status information of the any storage cluster, a third data amount in the any storage cluster after compression and a fourth data amount in the any storage cluster before compression before the cloud disk to be created is created in the any storage cluster;
determining, based on the historical cloud disk usage status information, a fifth data amount in the cloud disk to be created after compression and a sixth data amount in the cloud disk to be created before compression; and
determining a sum of the third data amount and the fifth data amount as the first data amount, determining a sum of the fourth data amount and the sixth data amount as the second data amount, and obtaining the ratio of the first data amount to the second data amount.

4. The method according to claim 3, wherein determining, based on the current storage status information of the any storage cluster, the third data amount in the any storage cluster after compression and the fourth data amount in the any storage cluster before compression before the cloud disk to be created is created in the any storage cluster comprises:
obtaining a product of a current total capacity of the any storage cluster, an average usage rate of cloud disks comprised in the any storage cluster, and a current compression rate of the any storage cluster, as the third data amount, and obtaining a product of the current total capacity of the any storage cluster and the average usage rate of the cloud disks comprised in the any storage cluster, as the fourth data amount; and/or
wherein determining, based on the historical cloud disk usage status information, the fifth data amount in the cloud disk to be created after compression and the sixth data amount in the cloud disk to be created before compression comprises:
obtaining a product of an average cloud disk usage rate of the user to whom the cloud disk to be created belongs, a historical compression rate of the user, a number of the cloud disk to be created, and an average capacity of the cloud disk to be created, as the fifth data amount, and obtaining a product of the average cloud disk usage rate of the user to whom the cloud disk to be created belongs, the number of the cloud disk to be created, and the average capacity of the cloud disk to be created, as the sixth data amount.

5. The method according to claim 2, wherein obtaining the predicted compression rate of the any storage cluster based on the ratio comprises:
determining a product of the ratio and a preset adjustment factor, as the predicted compression rate of the any storage cluster;
wherein the preset adjustment factor is determined based on a difference between a predicted compression rate and an actual compression rate of a historical target storage cluster in a historical cloud disk creation process and a preset learning rate.

6. The method according claim 1, wherein determining the target storage cluster from the respective storage clusters based on the predicted compression rates of the respective storage clusters and creating the cloud disk to be created in the target storage cluster, such that the difference between compression rates of the respective storage clusters is minimized after the cloud disk to be created is created in the target storage cluster comprises:
in a case that the cloud disk to be created is created in the any storage cluster, constructing, based on a predicted compression rate of the any storage cluster and actual compression rates of other storage clusters except the any storage cluster, a target function for characterizing a difference between the compression rates of the respective storage clusters, and determining a numerical value of the target function; and
determining the target storage cluster based on numerical values of the target function in cases that the cloud disk to be created is created in the respective storage clusters, and creating the cloud disk to be created in the target storage cluster.

7. The method according to claim 6, wherein constructing, based on the predicted compression rate of the any storage cluster and the actual compression rates of the other storage clusters except the any storage cluster, the target function for characterizing the difference between the compression rates of the respective storage clusters comprises:
determining a standard deviation of the compression rates, a maximum compression rate and a minimum compression rate of the respective storage clusters based on the predicted compression rate of the any storage cluster and the actual compression rates of the other storage clusters except the any storage cluster; and
normalizing the standard deviation of the compression rates of the respective storage clusters based on the maximum compression rate and the minimum compression rate, and obtaining the target function for characterizing the difference between the compression rates of the respective storage clusters based on a normalization result.

8. The method according to claim 1, wherein obtaining the historical cloud disk usage status information of the user to whom the cloud disk to be created belongs comprises:
in response to there being no historical cloud disk usage status information of the user to whom the cloud disk to be created belongs, or the historical cloud disk usage status information being unavailable, determining a similar user group with respect to the user to whom the cloud disk to be created belongs, and determining historical cloud disk usage status information of the similar user group as the historical cloud disk usage status information of the user to whom the cloud disk to be created belongs.

9. An electronic device, comprising: at least one processor and a memory;
wherein the memory stores computer-executable instructions; and
the at least one processor executes the computer-executable instructions stored in the memory to cause the electronic device to:
obtain historical cloud disk usage status information of a user to whom a cloud disk to be created belongs, and current storage status information of respective storage clusters, wherein any storage cluster comprises one or more created cloud disks;
predict, based on the historical cloud disk usage status information and the current storage status information of the respective storage clusters, predicted compression rates of the respective storage clusters in cases that the cloud disk to be created is created in the respective storage clusters; and
determine a target storage cluster from the respective storage clusters based on the predicted compression rates of the respective storage clusters, and create the cloud disk to be created in the target storage cluster, such that a difference between compression rates of the respective storage clusters is minimized after the cloud disk to be created is created in the target storage cluster.

10. The electronic device according to claim 9, wherein the computer-executable instructions to predict, based on the historical cloud disk usage status information and the current storage status information of the respective storage clusters, the predicted compression rates of the respective storage clusters in the cases that the cloud disk to be created is created in the respective storage clusters comprise instructions to:
determine, based on the historical cloud disk usage status information and the current storage status information of any storage cluster, a ratio of a first data amount in the any storage cluster after compression to a second data amount in the any storage cluster before compression in a case that the cloud disk to be created is created in the any storage cluster, and obtain a predicted compression rate of the any storage cluster based on the ratio.

11. The electronic device according to claim 9, wherein the computer-executable instructions to determine, based on the historical cloud disk usage status information and the current storage status information of the any storage cluster, the ratio of the first data amount in the any storage cluster after compression to the second data amount in the any storage cluster before compression in the case that the cloud disk to be created is created in the any storage cluster comprise instructions to:
determine, based on the current storage status information of the any storage cluster, a third data amount in the any storage cluster after compression and a fourth data amount in the any storage cluster before compression before the cloud disk to be created is created in the any storage cluster;
determine, based on the historical cloud disk usage status information, a fifth data amount in the cloud disk to be created after compression and a sixth data amount in the cloud disk to be created before compression; and
determine a sum of the third data amount and the fifth data amount as the first data amount, determine a sum of the fourth data amount and the sixth data amount as the second data amount, and obtain the ratio of the first data amount to the second data amount.

12. The electronic device according to claim 11, wherein the computer-executable instructions to determine, based on the current storage status information of the any storage cluster, the third data amount in the any storage cluster after compression and the fourth data amount in the any storage cluster before compression before the cloud disk to be created is created in the any storage cluster comprise instructions to:
obtain a product of a current total capacity of the any storage cluster, an average usage rate of cloud disks comprised in the any storage cluster, and a current compression rate of the any storage cluster, as the third data amount, and obtain a product of the current total capacity of the any storage cluster and the average usage rate of the cloud disks comprised in the any storage cluster, as the fourth data amount; and/or
wherein the computer-executable instructions to determine, based on the historical cloud disk usage status information, the fifth data amount in the cloud disk to be created after compression and the sixth data amount in the cloud disk to be created before compression comprise instructions to:
obtain a product of an average cloud disk usage rate of the user to whom the cloud disk to be created belongs, a historical compression rate of the user, a number of the cloud disk to be created, and an average capacity of the cloud disk to be created, as the fifth data amount, and obtain a product of the average cloud disk usage rate of the user to whom the cloud disk to be created belongs, the number of the cloud disk to be created, and the average capacity of the cloud disk to be created, as the sixth data amount.

13. The electronic device according to claim 10, wherein the computer-executable instructions to obtain the predicted compression rate of the any storage cluster based on the ratio comprise instructions to:
determine a product of the ratio and a preset adjustment factor, as the predicted compression rate of the any storage cluster;
wherein the preset adjustment factor is determined based on a difference between a predicted compression rate and an actual compression rate of a historical target storage cluster in a historical cloud disk creation process and a preset learning rate.

14. The electronic device according to claim 9, wherein the computer-executable instructions to determine the target storage cluster from the respective storage clusters based on the predicted compression rates of the respective storage clusters and creating the cloud disk to be created in the target storage cluster, such that the difference between compression rates of the respective storage clusters is minimized after the cloud disk to be created is created in the target storage cluster comprise instructions to:
in a case that the cloud disk to be created is created in the any storage cluster, construct, based on a predicted compression rate of the any storage cluster and actual compression rates of other storage clusters except the any storage cluster, a target function for characterizing a difference between the compression rates of the respective storage clusters, and determining a numerical value of the target function; and
determine the target storage cluster based on numerical values of the target function in cases that the cloud disk to be created is created in the respective storage clusters, and create the cloud disk to be created in the target storage cluster.

15. The electronic device according to claim 14, wherein the computer-executable instructions to construct, based on the predicted compression rate of the any storage cluster and the actual compression rates of the other storage clusters except the any storage cluster, the target function for characterizing the difference between the compression rates of the respective storage clusters comprise instructions to:
determine a standard deviation of the compression rates, a maximum compression rate and a minimum compression rate of the respective storage clusters based on the predicted compression rate of the any storage cluster and the actual compression rates of the other storage clusters except the any storage cluster; and
normalize the standard deviation of the compression rates of the respective storage clusters based on the maximum compression rate and the minimum compression rate, and obtain the target function for characterizing the difference between the compression rates of the respective storage clusters based on a normalization result.

16. The electronic device according to claim 9, wherein the computer-executable instructions to obtain the historical cloud disk usage status information of the user to whom the cloud disk to be created belongs comprise instructions to:
in response to there being no historical cloud disk usage status information of the user to whom the cloud disk to be created belongs, or the historical cloud disk usage status information being unavailable, determine a similar user group with respect to the user to whom the cloud disk to be created belongs, and determine historical cloud disk usage status information of the similar user group as the historical cloud disk usage status information of the user to whom the cloud disk to be created belongs.

17. A non-transitory computer-readable storage medium, wherein the computer-readable storage medium stores computer-executable instructions which, when executed by a processor, cause a computer to:
obtain historical cloud disk usage status information of a user to whom a cloud disk to be created belongs, and current storage status information of respective storage clusters, wherein any storage cluster comprises one or more created cloud disks;
predict, based on the historical cloud disk usage status information and the current storage status information of the respective storage clusters, predicted compression rates of the respective storage clusters in cases that the cloud disk to be created is created in the respective storage clusters; and
determine a target storage cluster from the respective storage clusters based on the predicted compression rates of the respective storage clusters, and create the cloud disk to be created in the target storage cluster, such that a difference between compression rates of the respective storage clusters is minimized after the cloud disk to be created is created in the target storage cluster.

18. The non-transitory computer-readable storage medium according to claim 17, wherein the computer-executable instructions to predict, based on the historical cloud disk usage status information and the current storage status information of the respective storage clusters, the predicted compression rates of the respective storage clusters in the cases that the cloud disk to be created is created in the respective storage clusters comprise instructions to:
determine, based on the historical cloud disk usage status information and the current storage status information of any storage cluster, a ratio of a first data amount in the any storage cluster after compression to a second data amount in the any storage cluster before compression in a case that the cloud disk to be created is created in the any storage cluster, and obtain a predicted compression rate of the any storage cluster based on the ratio.

19. The non-transitory computer-readable storage medium according to claim 18, wherein the computer-executable instructions to determine, based on the historical cloud disk usage status information and the current storage status information of the any storage cluster, the ratio of the first data amount in the any storage cluster after compression to the second data amount in the any storage cluster before compression in the case that the cloud disk to be created is created in the any storage cluster comprise instructions to:
determine, based on the current storage status information of the any storage cluster, a third data amount in the any storage cluster after compression and a fourth data amount in the any storage cluster before compression before the cloud disk to be created is created in the any storage cluster;
determine, based on the historical cloud disk usage status information, a fifth data amount in the cloud disk to be created after compression and a sixth data amount in the cloud disk to be created before compression; and
determine a sum of the third data amount and the fifth data amount as the first data amount, determine a sum of the fourth data amount and the sixth data amount as the second data amount, and obtain the ratio of the first data amount to the second data amount.

20. The non-transitory computer-readable storage medium according to claim 19, wherein the computer-executable instructions to determine, based on the current storage status information of the any storage cluster, the third data amount in the any storage cluster after compression and the fourth data amount in the any storage cluster before compression before the cloud disk to be created is created in the any storage cluster comprise instructions to:
obtain a product of a current total capacity of the any storage cluster, an average usage rate of cloud disks comprised in the any storage cluster, and a current compression rate of the any storage cluster, as the third data amount, and obtain a product of the current total capacity of the any storage cluster and the average usage rate of the cloud disks comprised in the any storage cluster, as the fourth data amount; and/or
wherein the computer-executable instructions to determine, based on the historical cloud disk usage status information, the fifth data amount in the cloud disk to be created after compression and the sixth data amount in the cloud disk to be created before compression comprise instructions to:
obtain a product of an average cloud disk usage rate of the user to whom the cloud disk to be created belongs, a historical compression rate of the user, a number of the cloud disk to be created, and an average capacity of the cloud disk to be created, as the fifth data amount, and obtain a product of the average cloud disk usage rate of the user to whom the cloud disk to be created belongs, the number of the cloud disk to be created, and the average capacity of the cloud disk to be created, as the sixth data amount.
